(19) United States
(12) Patent Application Publication
(10) Pub. No.: US 2017/0195206 A1
(43) Pub. Date: Jul. 6, 2017

(54) METHOD AND ELECTRONIC DEVICE FOR CONTROLLING NETWORKING STATE OF TERMINAL

(71) Applicants: Le Holdings (Beijing) Co., Ltd., Beijing (CN); Lemobile Information Technology (Beijing) Co., Ltd., Beijing (CN)

(72) Inventor: Huisong Wang, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/243,597

(22) Filed: Aug. 22, 2016

Related U.S. Application Data
(63) Continuation of application No. PCT/CN2016/088524, filed on Jul. 5, 2016.

(30) Foreign Application Priority Data
Dec. 31, 2015 (CN) 201511032610.0

(51) Int. Cl. H04L 12/26

(52) U.S. Cl. CPC H04L 43/0882; H04L 43/062

(57) ABSTRACT

This disclosure provides a method and electronic device for controlling the networking state of a terminal. The method includes the following steps: acquiring a total remaining traffic and time information corresponding to the total remaining traffic information; determining a monitoring period according to the time information; calculating and judging whether the actually used traffic of the terminal exceeds the total remaining traffic or not in real time in each monitoring period; and when the calculated actually used traffic exceeds the remaining traffic, controlling the terminal to disconnect network connection.

### CROSS REFERENCE TO RELATED APPLICATIONS

This disclosure is a continuation of International Application No. PCT/CN2016/088524 filed on Jul. 5, 2016, which is based upon and claims priority to Chinese Patent Application No. 201511032610.0, filed on Dec. 31, 2015, titled “METHOD AND DEVICE FOR CONTROLLING NETWORKING STATE OF TERMINAL”, and the entire contents of which are incorporated herein by reference.

### TECHNICAL FIELD

This disclosure relates to the field of smart terminal control, and particularly relates to a method and electronic device for controlling the networking state of a terminal.

### BACKGROUND

When smart terminals such as smart phones, tablet PCs and the like connect a network of a service provider, certain communication cost is required to be paid. Particularly, when a smart phone connects a GSM (Global System for Mobile Communication) network, at present an operator generally adopts a charging rule of: providing a fixed traffic for a subscriber every month, and agreeing with the subscriber about monthly payment; if the total traffic of the subscriber in the current month does not exceed the abovementioned fixed traffic, charging according to a standard of the monthly payment; and if the total traffic of the subscriber in the current month exceeds the abovementioned fixed traffic, charging the exceeded part according to another charging standard. Generally, the standard of the monthly payment may save the communication cost for the subscriber. Therefore, the subscriber needs to monitor the traffic usage of his terminal in order to try not to exceed the monthly fixed traffic.

With the continuous development of terminal applications, the applications have increasingly more abundant functions, and most applications will perform communication operations, such as downloading update data. These operations are very likely to be not subject to the subscriber's subjective control, and automatically perform communication as long as the terminal is in a networking state. Therefore, it is very likely to be difficult to control the communication traffic, thereby increasing the communication cost of the subscriber. Currently, there are some applications for monitoring the traffic, which can assist the subscriber to monitor the traffic usage of the terminal and control the networking state of the terminal according to the monitoring. But the existing monitoring way only monitors the terminal in all time according to the remaining traffic input by the subscriber, without considering that some fixed traffic is limited to time periods. Therefore, in the process of monitoring, the remaining traffic is very likely to be wrongly determined, resulting in inaccurate monitoring of the remaining traffic and eventually improperly controlling the networking state of the terminal.

### SUMMARY

This disclosure provides a method and electronic device for controlling the networking state of a terminal, by which the traffic usage of a subscriber can be accurately judged, and then the networking state of the terminal can be correctly controlled, thereby effectively avoiding overuse of various time division traffics by the subscriber, and further saving the communication cost for the subscriber.

One objective of the embodiments of this disclosure is to provide a method for controlling the networking state of a terminal, including the following steps: acquiring a total remaining traffic and time information corresponding to the total remaining traffic information; determining a monitoring period according to the time information; calculating and judging whether the actually used traffic of the terminal exceeds the total remaining traffic or not in real time in the monitoring period; and controlling the terminal to disconnect network connection when the calculated actually used traffic exceeds the remaining traffic.

Preferably, the total remaining traffic includes a first remaining traffic and a second remaining traffic, and the monitoring period includes a first monitoring period and a second monitoring period, where the first monitoring period does not coincide with the second monitoring period.

Preferably, the step of judging whether the calculated actually used traffic exceeds the total remaining traffic or not in real time includes calculating and judging whether a first actually used traffic exceeds the first remaining traffic or not in the first monitoring period; when the first actually used traffic exceeds the first remaining traffic, determining that the calculated actually used traffic exceeds the total remaining traffic; when the first actually used traffic does not exceed the first remaining traffic, calculating and judging whether a second actually used traffic exceeds the second remaining traffic or not in the second monitoring period; when the second actually used traffic exceeds the second remaining traffic, judging whether the exceeded second actually used traffic exceeds the current first remaining traffic or not; and when the exceeded second actually used traffic exceeds the current first remaining traffic, determining that the calculated actually used traffic exceeds the total remaining traffic.

Preferably, the step of acquiring a remaining traffic and a preset usage time corresponding to the remaining traffic information includes sending a remaining traffic statistical request to a server; receiving the remaining traffic and time information corresponding to the remaining traffic, which are fed back by the server; acquiring a calibrated traffic input by a subscriber; and calculating the total remaining traffic according to the remaining traffic fed back by the server and the calibrated traffic.

Another objective of the embodiments of this disclosure is to provide an electronic device comprising at least one processor, and a memory in communication connection with the at least one processor, where the memory stores instructions that can be executed by the at least one processor, and the instructions are executed by the at least one processor to enable the at least processor to: acquire a total remaining traffic and time information corresponding to the total remaining traffic information; determine a monitoring period according to the time information; calculate and judge whether the actually used traffic of the terminal exceeds the total remaining traffic or not in real time in the monitoring period; and when the calculated actually used traffic exceeds the remaining traffic, control the terminal to disconnect network connection.

About the electronic device, where, the total remaining traffic includes a first remaining traffic and a second remaining traffic, and the monitoring period includes a first monitoring period and a second monitoring period, where the first monitoring period does not coincide with the second monitoring period.

About the electronic device, where, the step of judging whether the calculated actually used traffic exceeds the total remaining traffic or not in real time includes: calculating and judging whether a first actually used traffic exceeds the first remaining traffic or not in the first monitoring period; when the first actually used traffic exceeds the first remaining traffic, determining that the calculated actually used traffic exceeds the total remaining traffic; when the first actually used traffic does not exceed the first remaining traffic, calculating and judging whether a second actually used traffic exceeds the second remaining traffic or not in the second monitoring period; when the second actually used traffic exceeds the second remaining traffic, judging whether the exceeded second actually used traffic exceeds the current first remaining traffic or not; and when the exceeded second actually used traffic exceeds the current first remaining traffic, determining that the calculated actually used traffic exceeds the total remaining traffic.

About the electronic device, where, the step of acquiring a remaining traffic and a preset usage time corresponding to the remaining traffic information includes: sending a remaining traffic statistical request to a server; receiving the remaining traffic and time information corresponding to the remaining traffic, which are fed back by the server; acquiring a calibrated traffic input by a subscriber; and calculating the total remaining traffic according to the remaining traffic fed back by the server and the calibrated traffic.

Another objective of the embodiments of this disclosure is to provide a non-volatile computer storage medium storing computer executable instructions that, when executed by the electronic device, enable the electronic device to: acquire the total remaining traffic and time information corresponding to the total remaining traffic information; determine a monitoring period according to the time information; calculate and judge whether the actually used traffic of the terminal exceeds the total remaining traffic or not in real time in the monitoring period; and when the calculated actually used traffic exceeds the remaining traffic, control the terminal to disconnect network connection.

For the non-volatile computer storage medium, where, the total remaining traffic includes a first remaining traffic and a second remaining traffic, and the monitoring period includes a first monitoring period and a second monitoring period, where the first monitoring period does not coincide with the second monitoring period.

For the non-volatile computer storage medium, where, the step of judging whether the calculated actually used traffic exceeds the total remaining traffic or not in real time includes: calculating and judging whether a first actually used traffic exceeds the first remaining traffic or not in the first monitoring period; when the first actually used traffic exceeds the first remaining traffic, determining that the calculated actually used traffic exceeds the total remaining traffic; when the first actually used traffic does not exceed the first remaining traffic, calculating and judging whether a second actually used traffic exceeds the second remaining traffic or not in the second monitoring period; when the second actually used traffic exceeds the second remaining traffic, judging whether the exceeded second actually used traffic exceeds the current first remaining traffic or not; and when the exceeded second actually used traffic exceeds the current first remaining traffic, determining that the calculated actually used traffic exceeds the total remaining traffic.

For the non-volatile computer storage medium, where, the step of acquiring the remaining traffic and the preset usage time corresponding to the remaining traffic information includes: sending a remaining traffic statistical request to a server; receiving the remaining traffic and time information corresponding to the remaining traffic, which are fed back by the server; acquiring a calibrated traffic input by a subscriber; and calculating the total remaining traffic according to the remaining traffic fed back by the server and the calibrated traffic.

The method and electronic device for controlling the networking state of the terminal, provided by this disclosure, are particularly applicable to monitoring time-division traffic, determine every monitoring period according to the total remaining traffic and the time information, then calculate the actually used various time division traffics of the terminal in real time in different monitoring periods, and judge whether the calculated traffic used in each time division exceeds the total remaining traffic or not in real time, so as to accurately determine the traffic usage of the subscriber, and then correctly control the networking state of the terminal. The technical solution of the present disclosure helps the subscriber to effectively avoid overusing various time division traffics, and then saves the communication cost of the subscriber.

### BRIEF DESCRIPTION OF DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 is a flow chart of a method for controlling the networking state of a terminal according to embodiment 1 of this disclosure;

FIG. 2 is a flow chart of a method for controlling the networking state of a terminal according to embodiment 2 of this disclosure;

FIG. 3 is a structural diagram of a device for controlling the networking state of a terminal according to embodiment 3 of this disclosure; and

FIG. 4 is a schematic diagram of a hardware structure of an electronic device for executing the method for controlling the networking state of a terminal according to embodiment 5 of this disclosure.

### DETAILED DESCRIPTION

To make the objectives, the technical scheme and the advantages of the embodiments of this disclosure clearer, the technical scheme of this disclosure will be clearly and completely described hereinafter through implementation with reference to the accompanying drawings in the embodiments of this disclosure. Apparently, the embodiments described below are a part, instead of all, of the embodiments of this disclosure.

### Embodiment 1

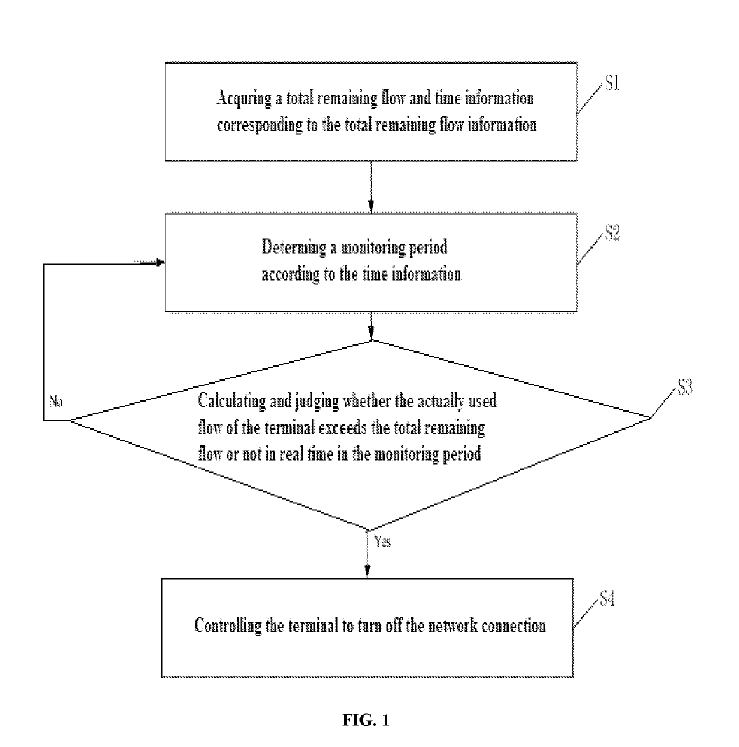

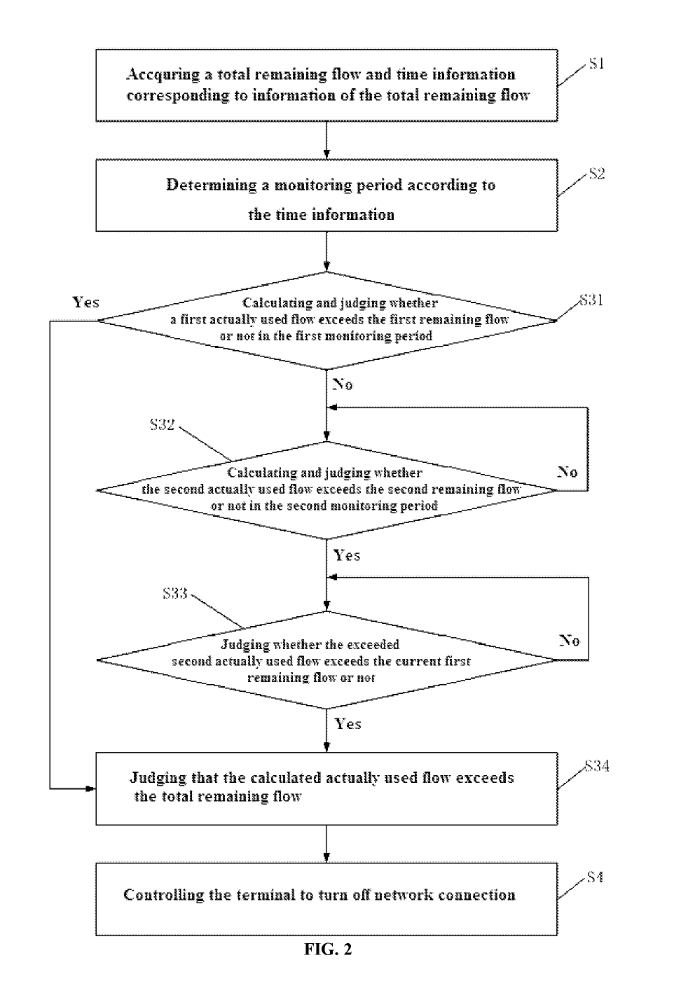

The embodiment of this disclosure provides a method for controlling the networking state of a terminal, and the method can be executed in a smart communication terminal, where the networking state may be a connection state of the terminal with a GSM (Global System for Mobile Communication) network, and as shown in FIG. 1, the method includes the following steps:

S1, acquiring a total remaining traffic and time information corresponding to the total remaining traffic information. The term of traffic used in the present disclosure is a special term in the field of network information technology, the mobile phone traffic refers to traffic data generated when a mobile phone surfs the internet, the mobile phone exchanges data with a server when a subscriber opens software or performs internet operations through the mobile phone, and the traffic refers to values of such data, in units including B, KB, MB, GB and the like. As everyone knows, the “time division traffic” refers to that the subscriber can enjoy different remaining traffics in different time periods, and the time division traffic not only includes the traffic volume and but also is bound to include time information corresponding to the traffic volume. There are multiple ways of obtaining the remaining traffic information and the time information, for example, directly inputting by the subscriber or query to a service provider by the terminal is feasible.

The total remaining traffic includes multiple conditions, for example, there may be only one type of remaining traffic with a value of 1 GB and time information of 23:00-8:00; or there may be two types of traffics at the same time, the first type of traffic is 500 MB with the time information of 00:00-24:00, and the second type of traffic is 1 GB with the time information of 23:00-8:00. In order to clearly describe the technical solution of the present disclosure, the present embodiment firstly takes the condition that there is only one type of remaining traffic as an example for illustration. It is supposed that the currently acquired remaining traffic is 1 GB with the time information of 23:00-8:00.

S2, determining a monitoring period according to the time information, where the determined monitoring period may be 23:00-8:00 every day.

S3, calculating and judging whether the actually used traffic of the terminal exceeds the total remaining traffic or not in real time in the monitoring period, namely judging whether the traffic used by each disclosure exceeds 1 GB or not in real time in the abovementioned period, executing S5 if the traffic used by each disclosure exceeds 1 GB in real time in the abovementioned period, or judging after continuously collecting statistical data, where there are many ways to calculate the traffic used by an disclosure, for example, for a terminal based on an Android system, the traffic usage of all disclosure can be calculated by accessing a document on statistical data of traffic of each disclosure, and for other mobile terminal operating systems, such as Windows system, IOS and the like, they also include interfaces or documents on statistical data of traffic of disclosure. Therefore, the method is feasible for various terminal operating systems. Some disclosure may automatically use the traffic at any time, and therefore the process of collecting the traffic usage of the disclosure is a real-time dynamic process, namely performing collection and judging operations in real time in the abovementioned period.

S4, when the calculated actually used traffic exceeds the remaining traffic, controlling the terminal to disconnect network connection. For example, an instruction for disconnecting a GSM network can be transmitted to a mobile communication module of the terminal.

The method for controlling the networking state of a terminal, provided by the present disclosure, is particularly applicable to monitoring time division traffic, determines every monitoring period according to the total remaining traffic and the time information of the terminal, then calculates the actually used various time division traffics of the terminal in real time in different monitoring periods, and determines whether the calculated traffic used in each time division exceeds the total remaining traffic or not in real time, so as to accurately determine the traffic usage of the subscriber and further correctly control the networking state of the terminal. The technical solution of the present disclosure helps the subscriber to effectively avoid overusing various time division traffics, and then saves the communication cost of the subscriber.

As a preferred embodiment, the abovementioned step S1 may include the following substeps:

S11, sending a remaining traffic statistical request to a server, where the server may be an operator's server side providing network operation services, and the statistical request includes a variety of contents which are specifically set according to query instructions specified by an operator.

S12, receiving the remaining traffic and time information corresponding to the remaining traffic, which are fed back by the server. Generally, an operator server will feed back the remaining traffic condition and type (including a time division traffic, a common traffic and the like) of the subscriber in the form of text messages, and traffic information and time information may be extracted from such text messages in actual disclosure.

S13, acquiring a calibrated traffic input by the subscriber, where the calibrated traffic also is a numerical value and generally refers to a traffic obtained by the subscriber in a special way, and it is difficult to collect the statistical data of this type of traffic through the abovementioned steps S11 and S12. For example, the subscriber can determine acquiring some extra traffic, or temporarily cancel an existing initial traffic.

S14, calculating the total remaining traffic according to the remaining traffic fed back by the server and the calibrated traffic, where the additionally acquired calibrated traffic and the traffic fed back by the server are added together to obtain a final total traffic, and the temporarily canceled calibrated traffic can be subtracted from the traffic fed back by the server to obtain the final total traffic.

The abovementioned preferred solution can automatically acquire the remaining traffic of the subscriber by sending an instruction for collecting statistical data to the server, and accept an autonomous calibration operation of the subscriber, so as to correct the remaining traffic fed back by the server, so that the finally obtained total remaining traffic is more accurate, and then the result of judgment as to whether the used traffic exceeds the total remaining traffic or not is more accurate.

### Embodiment 2

The embodiment of this disclosure provides a method for controlling the networking state of a terminal, and is different from the previous embodiment in the aspect that in the present embodiment, the total remaining traffic includes a first remaining traffic and a second remaining traffic, and the monitoring periods include a first monitoring period and a second monitoring period, where the first monitoring period does not coincide with the second monitoring period.

The present embodiment is particularly suitable for a subscriber having normal traffic and leisure traffic, for example, the first type of traffic in the abovementioned two types of traffics is 500 MB with the time information of 00:00-24:00, and the second type of traffic is 1 GB with the time information of 23:00-8:00. The abovementioned first type of traffic can be known as the normal traffic, the second type of traffic can be known as the leisure traffic, and according to a charging rule of a service provider, during the period of 08:00-23:00, extra traffic is generated after the normal traffic is used up, and then an extra fee will be charged; and during the period of 23:00-8:00, if the leisure traffic is used up but there is normal traffic available, the traffic will be included in the normal traffic, and only when both the normal traffic and the leisure traffic are used up, will the extra fee be charged.

Thus, it can be determined that the set monitoring period is not bound to be equal to the abovementioned time information, and for the abovementioned condition, the second monitoring period is equal to the time information, namely 23:00-8:00. However, the first monitoring period should be complementary to the second monitoring period, namely 08:00-23:00.

For the abovementioned condition, the method may include the following steps:

S1, acquiring a total remaining traffic and time information corresponding to the total remaining traffic information, where specifically, two groups of information may be acquired, the first group is a first remaining traffic of 500 MB in the period of 00:00-24:00, and a second remaining traffic is 1 GB in the period of 23:00-8:00. Similar to the principle of the previous embodiment, the abovementioned two types of remaining traffics and time information can be acquired from a server end of a service provider, and also can be manually calibrated by a subscriber.

S2, determining a monitoring period according to the time information, where specifically, a first monitoring period (08:00-23:00) can be determined according to the time information of the first remaining traffic, and a second monitoring period (23:00-8:00) can be determined according to the time information of the second remaining traffic.

As a preferred embodiment, the abovementioned step S3 may specifically include the following substeps:

S31, calculating and judging whether a first actually used traffic exceeds the first remaining traffic or not in the first monitoring period, namely judging whether the traffic value used in the period of 08:00-23:00 by the terminal exceeds 500 MB or not, if the traffic value used in the period of 08:00-23:00 by the terminal exceeds 500 MB, it means that the first remaining traffic is used up by a subscriber in the first period, and executing step S34, or otherwise, executing step S32.

S32, calculating and judging whether the second actually used traffic exceeds the second remaining traffic or not in the second monitoring period, namely, assuming that the value of traffic used by the terminal in the period of 08:00-23:00 is 300 MB (the first remaining traffic becomes 200 MB at this time) and then entering the second monitoring period, judging whether the value of traffic used by the terminal in the period of 23:00-08:00 exceeds 1 GB or not, if the value of traffic used in the period of 23:00-08:00 by the terminal exceeds 1 GB, executing step S33, or otherwise, continuing calculation and monitoring.

S33, judging whether the exceeded second actually used traffic exceeds the current first remaining traffic or not. For example, assuming that the value of traffic used by the terminal in the period of 23:00-8:00 is 1.4 GB, the exceeded actually used traffic is 0.4 GB, equivalent to 400 MB. Although the second remaining traffic (1 GB) is used up by the subscriber in the second period, according to the charging rule of the service provider, if the first remaining traffic is not used up at this time, the exceeded traffic can be deducted from the current first remaining traffic, and the step S34 will be executed only when the exceeded second actually used traffic exceeds the current first remaining traffic; and as mentioned above, as the exceeded second actually used traffic is 400 MB and the current first remaining traffic is 200 MB, the step S34 will be executed.

S34, judging that the calculated actually used traffic exceeds the total remaining traffic, namely judging that the traffic used by the terminal in the period of 23:00-8:00 exceeds the second remaining traffic and the exceeded part is greater than the current first remaining traffic, and then executing step S4.

S4, when the calculated actually used traffic exceeds the remaining traffic, controlling the terminal to disconnect network connection.

According to the abovementioned preferred solutions, the normal traffic and leisure traffic of the subscriber are monitored and controlled respectively. By adopting different determination strategies in different monitoring periods, the actual usage conditions of the two types of traffics by the subscriber can be accurately determined, and then the networking state of the terminal is controlled according to the usage conditions of the two types of traffics, so that the subscriber can more effectively avoid overusing various time division traffics.

### Embodiment 3

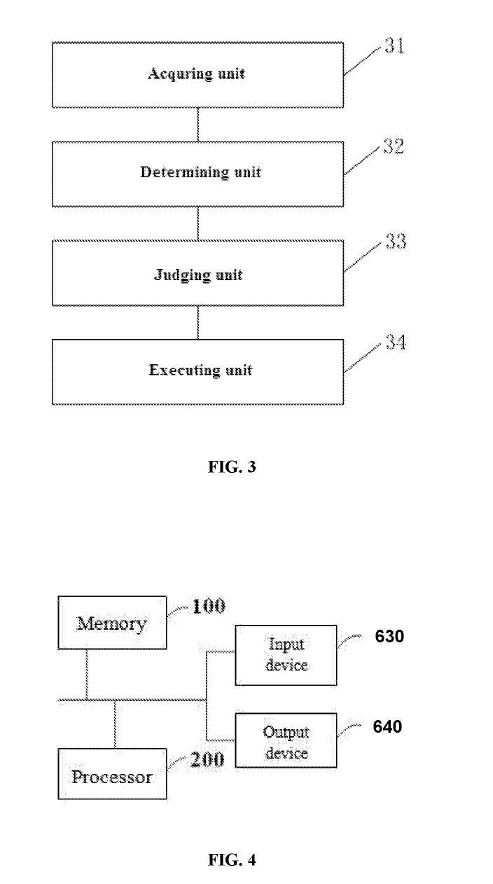

The embodiment of this disclosure provides a device for controlling the networking state of a terminal. As shown in FIG. 3, the device includes the following units:

an acquiring unit 31, for acquiring a total remaining traffic and time information corresponding to the total remaining traffic information;

a determining unit 32, for determining a monitoring period according to the time information;

a judging unit 33, for calculating and judging whether the actually used traffic of the terminal exceeds the total remaining traffic or not in real time in the monitoring period; and

an executing unit 34, for, when the calculated actually used traffic exceeds the remaining traffic, controlling the terminal to disconnect network connection.

The device for controlling the networking state of the terminal, provided by the embodiment of this disclosure is particularly applicable to monitoring time division traffic, determines each monitoring period according to the total remaining traffic and the time information, and then calculates each time division traffic in each monitoring period actually used by the terminal in real time and judges whether the traffic used in each time division period exceeds the total remaining traffic in real time, so as to accurately determine the subscriber's traffic usage and then properly control networking state of the terminal. The technical solution of this invention helps subscribers to effectively avoid overusing various time division traffics, and then saves cost of communication for subscribers.

Preferably, the total remaining traffic includes a first remaining traffic and a second remaining traffic, and the monitoring period includes a first monitoring period and a second monitoring period, where the first monitoring period does not coincide with the second monitoring period.

Preferably, the judging unit 33 includes the following units:

a first judging unit, for calculating and judging whether a first actually used traffic exceeds the first remaining traffic or not in the first monitoring period;

a determining unit, for when the first actually used traffic exceeds the first remaining traffic, determining that the calculated actually used traffic exceeds the total remaining traffic;

a second judging unit, for, when the first actually used traffic does not exceed the first remaining traffic, calculating and judging whether a second actually used traffic exceeds the second remaining traffic or not in the second monitoring period;

a third judging unit, for when the second actually used traffic exceeds the second remaining traffic, judging whether the exceeded second actually used traffic exceeds the current first remaining traffic or not; and

a second determining unit, for when the exceeded second actually used traffic exceeds the current first remaining traffic, judging that the calculated actually used traffic exceeds the total remaining traffic.

The above preferred embodiment respectively monitors and judges the normal traffic and leisure traffic possessed by a subscriber, accurately determines the actual usage of the two types of traffics using different judging strategies in different monitoring periods, and then controls the networking state of the terminal according to the actual usage of the two types of traffics, so as to more effectively avoid overusing various time division traffics by the subscriber.

Preferably, the acquiring unit 31 includes the following units:

a sending unit, for sending a remaining traffic statistical request to a server; a receiving unit, for receiving the remaining traffic and time information corresponding to the remaining traffic, which are fed back by the server;

an inputting unit, for acquiring a calibrated traffic input by a subscriber; and

a calibrating unit, for calculating the total remaining traffic according to the remaining traffic fed back by the server and the calibrated traffic.

The abovementioned preferred embodiments can automatically acquire remaining traffic of a subscriber by sending a statistical instruction to the server, and receive autonomous calibration operation of the subscriber in order to calibrate the remaining traffic fed back by the server, so that the finally acquired total remaining traffic is more accurate, and then the result of judgment as to whether the traffic usage exceeds the total remaining traffic or not is more accurate.

### Embodiment 4

The embodiment of this disclosure provides a non-volatile computer storage medium storing computer executable instructions that, when executed by the electronic device, enable the electronic device to: acquire a total remaining traffic and time information corresponding to the total remaining traffic information; determine a monitoring period according to the time information; calculate and judge whether the actually used traffic of the terminal exceeds the total remaining traffic or not in real time in the monitoring period; and when the calculated actually used traffic exceeds the remaining traffic, control the terminal to disconnect network connection.

About the non-volatile computer storage medium, where, the total remaining traffic includes a first remaining traffic and a second remaining traffic, and the monitoring period includes a first monitoring period and a second monitoring period, where the first monitoring period does not coincide with the second monitoring period.

About the non-volatile computer storage medium, where, the step of judging whether the calculated actually used traffic exceeds the total remaining traffic or not in real time includes: calculating and judging whether a first actually used traffic exceeds the first remaining traffic or not in the first monitoring period; when the first actually used traffic exceeds the first remaining traffic, determining that the calculated actually used traffic exceeds the total remaining traffic; when the first actually used traffic does not exceed the first remaining traffic, calculating and judging whether a second actually used traffic exceeds the second remaining traffic or not in the second monitoring period; when the second actually used traffic exceeds the second remaining traffic, judging whether the exceeded second actually used traffic exceeds the current first remaining traffic or not; and when the exceeded second actually used traffic exceeds the current first remaining traffic, determining that the calculated actually used traffic exceeds the total remaining traffic.

About the non-volatile computer storage medium, where the step of acquiring a remaining traffic and a preset usage time corresponding to the remaining traffic information includes: sending a remaining traffic statistical request to a server; receiving the remaining traffic and time information corresponding to the remaining traffic, which are fed back by the server; acquiring calibrated traffic input by a subscriber; and calculating the total remaining traffic according to the remaining traffic fed back by the server and the calibrated traffic.

### Embodiment 5

FIG. 4 is a schematic diagram of a hardware structure of the electronic device for executing the method for controlling the networking state of the terminal in accordance with the embodiment of this disclosure, and as shown in FIG. 4, the device includes one or more processors 200 and a memory 100, and one processor 200 is taken as an example in FIG. 4; and the electronic device for executing the method for controlling the networking state of a terminal may also include an input device 630 and an output device 640.

The processor 200, the memory 100, the input device 630 and the output device 640 may be connected with a bus or in other ways, and bus connection is taken as an example in FIG. 4.

The memory 100, as a non-volatile computer readable storage medium, may be used for storing non-volatile software programs, non-volatile computer executable programs and modules, for example, program instructions/modules (e.g., an acquiring unit 31, a determining unit 32, a judging unit 33, and an executing unit 34 shown in FIG. 3) corresponding to the method for controlling the networking state of the terminal in the embodiments of this disclosure. The processor 200 runs the non-volatile software programs, instructions and modules stored in the memory 100 so as to execute various functional disclosure and data processing of a server, thereby implementing the method for controlling the networking state of the terminal in the abovementioned embodiments of the method.

The memory 100 may include a program storage area and a data storage area, where the program storage area may store an operating system and disclosure for at least one functions; and the data storage area may store data and the like created according to the use of the device for controlling the networking state of the terminal. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the device for controlling the networking state of the terminal through a network. An example of the network includes, but is not limited to, internet, intranet, LAN, mobile communication network, and the combinations thereof.

The input device 630 may receive input digit or character information, so as to generate a key signal input related to the user configuration and functional control of the device for controlling the networking state of the terminal. The output device 640 may include display devices such as a display screen.

The one or more modules are stored in the memory 100, and when executed by the one or more processors 200, perform the method for controlling the networking state of the terminal in any one of the abovementioned embodiments of the method.

The abovementioned product can perform the method provided by the embodiments of this disclosure and has corresponding functional modules for executing the method and beneficial effects. For more technical details in this embodiment, please refer to the method provided by the embodiments of this disclosure.

The electronic device of the embodiments of this disclosure exists in many forms, including but not limited to the following devices:

(1) Mobile communication devices: the characteristic of such devices is that they have a mobile communication function with a main goal of enabling voice and data communication. Such terminals include: smart phones (such as iPhone), multimedia phones, feature phones, low-end phones, etc.

(2) Ultra-mobile personal computer devices: such devices belong to the category of personal computers, have computing and processing functions, and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, a hard disk, an internal memory, a system bus, etc. A server has architecture similar to that of a general purpose computer, but in order to provide highly reliable services, the server has higher requirements in aspects of processing capability, stability, reliability, security, expandability, manageability, etc.

(5) Other electronic devices having data interaction function.

The abovementioned embodiments of devices are only illustrative, where the units described as separate parts may be or may not be physically separated, the components shown as units may be or may not be physical units, i.e. may be located in one place, or may be distributed at multiple network units. According to actual needs, part of or all of the modules therein may be selected to realize the objectives of the technical scheme of the embodiment.

By abovementioned descriptions of the implementations, those skilled in the art can clearly understand that the various implementations may be implemented by software and a general hardware platform, and of course, may also be implemented by hardware. Based on such understanding, the abovementioned technical scheme in essence, or the part thereof making contribution to related technology, may be embodied in the form of a software product, and such computer software products may be stored in a computer readable storage medium such as an ROM/RAM, a magnetic disk or an optical disk, etc., and may include a number of instructions to enable a computer device (which may be a personal computer, a server, or a network device) to execute the methods described in the various embodiments or in some parts thereof.

Finally, it should be noted that: the abovementioned embodiments are merely illustrated for describing rather than limiting the technical scheme of this disclosure; although detailed description of this disclosure is given with reference to the abovementioned embodiments, those skilled in the art should understand that they still can modify the technical scheme recorded in the abovementioned various embodiments or replace part of the technical features therein with equivalents; and these modifications or replacements would not cause the essence of the corresponding technical scheme to depart from the spirit and scope of the technical scheme of the various embodiments of this disclosure.

What is claimed is:

1. A method for controlling the networking state of a terminal, comprising the following steps:
acquiring a total remaining traffic and time information corresponding to the total remaining traffic information;
determining a monitoring period according to the time information;
calculating and judging whether the actually used traffic of the terminal exceeds the total remaining traffic or not in real time in the monitoring period; and
when the calculated actually used traffic exceeds the remaining traffic, controlling the terminal to disconnect network connection.

2. The method according to claim 1, wherein the total remaining traffic comprises a first remaining traffic and a second remaining traffic, and the monitoring period includes a first monitoring period and a second monitoring period, wherein the first monitoring period does not coincide with the second monitoring period.

3. The method according to claim 2, wherein the step of judging whether the calculated actually used traffic exceeds the total remaining traffic or not in real time comprises:
calculating and judging whether a first actually used traffic exceeds the first remaining traffic or not in the first monitoring period;
when the first actually used traffic exceeds the first remaining traffic, determining that the calculated actually used traffic exceeds the total remaining traffic;
when the first actually used traffic does not exceed the first remaining traffic, calculating and judging whether a second actually used traffic exceeds the second remaining traffic or not in the second monitoring period;
when the second actually used traffic exceeds the second remaining traffic, judging whether the exceeded second actually used traffic exceeds the current first remaining traffic or not; and
when the exceeded second actually used traffic exceeds the current first remaining traffic, determining that the calculated actually used traffic exceeds the total remaining traffic.

4. The method according to claim 1, wherein the step of acquiring a remaining traffic and a preset usage time corresponding to the remaining traffic information comprises:
sending a remaining traffic statistical request to a server;
receiving the remaining traffic and time information corresponding to the remaining traffic, which are fed back by the server;
acquiring a calibrated traffic input by a subscriber; and
calculating the total remaining traffic according to the remaining traffic fed back by the server and the calibrated traffic.

5. An electronic device, comprising:
at least one processor, and
a memory in communication connection with the at least one processor,
wherein the memory stores instructions that can be executed by the at least one processor, and the instructions are executed by the at least one processor to enable the at least one processor to:
acquire a total remaining traffic and time information corresponding to the total remaining traffic information;
determine a monitoring period according to the time information;
calculate and judge whether the actually used traffic of the terminal exceeds the total remaining traffic or not in real time in the monitoring period; and
when the calculated actually used traffic exceeds the remaining traffic, control the terminal to disconnect network connection.

6. The electronic device according to claim 5, wherein the total remaining traffic comprises a first remaining traffic and a second remaining traffic, and the monitoring period comprises a first monitoring period and a second monitoring period, wherein the first monitoring period does not coincide with the second monitoring period.

7. The electronic device according to claim 6, wherein the step of judging whether the calculated actually used traffic exceeds the total remaining traffic or not in real time comprises:
calculating and judging whether a first actually used traffic exceeds the first remaining traffic or not in the first monitoring period;
when the first actually used traffic exceeds the first remaining traffic, determining that the calculated actually used traffic exceeds the total remaining traffic;
when the first actually used traffic does not exceed the first remaining traffic, calculating and judging whether a second actually used traffic exceeds the second remaining traffic or not in the second monitoring period;
when the second actually used traffic exceeds the second remaining traffic, judging whether the exceeded second actually used traffic exceeds the current first remaining traffic or not; and
when the exceeded second actually used traffic exceeds the current first remaining traffic, determining that the calculated actually used traffic exceeds the total remaining traffic.

8. The electronic device according to claim 5, wherein the step of acquiring a remaining traffic and a preset usage time corresponding to the remaining traffic information comprises:
sending a remaining traffic statistical request to a server;
receiving the remaining traffic and time information corresponding to the remaining traffic, which are fed back by the server;
acquiring a calibrated traffic input by a subscriber; and
calculating the total remaining traffic according to the remaining traffic fed back by the server and the calibrated traffic.

9. A non-volatile computer storage medium, storing computer executable instructions that, when executed by the electronic device, enable the electronic device to:
acquire a total remaining traffic and time information corresponding to the total remaining traffic information;
determine a monitoring period according to the time information;
calculate and judge whether the actually used traffic of the terminal exceeds the total remaining traffic or not in real time in the monitoring period; and
when the calculated actually used traffic exceeds the remaining traffic, control the terminal to disconnect network connection.

10. The non-volatile computer storage medium according to claim 9, wherein the total remaining traffic comprises a first remaining traffic and a second remaining traffic, and the monitoring period includes a first monitoring period and a second monitoring period, wherein the first monitoring period does not coincide with the second monitoring period.

11. The non-volatile computer storage medium according to claim 10, wherein the step of judging whether the calculated actually used traffic exceeds the total remaining traffic or not in real time comprises:
calculating and judging whether a first actually used traffic exceeds the first remaining traffic or not in the first monitoring period;
when the first actually used traffic exceeds the first remaining traffic, determining that the calculated actually used traffic exceeds the total remaining traffic;
when the first actually used traffic does not exceed the first remaining traffic, calculating and judging whether a second actually used traffic exceeds the second remaining traffic or not in the second monitoring period;
when the second actually used traffic exceeds the second remaining traffic, judging whether the exceeded second actually used traffic exceeds the current first remaining traffic or not; and
when the exceeded second actually used traffic exceeds the current first remaining traffic, determining that the calculated actually used traffic exceeds the total remaining traffic.

12. The non-volatile computer storage medium according to claim 9, wherein the step of acquiring a remaining traffic and a preset usage time corresponding to the remaining traffic information comprises:
sending a remaining traffic statistical request to a server;
receiving the remaining traffic and time information corresponding to the remaining traffic, which are fed back by the server;
acquiring a calibration traffic input by a subscriber; and
calculating the total remaining traffic according to the remaining traffic fed back by the server and the calibrated traffic.
